(19) United States
(12) Patent Application Publication
(10) Pub. No.: US 2018/0180097 A1
(43) Pub. Date: Jun. 28, 2018

(54) DRAIN PROOF SEAT OF FLUID PRESSURE BEARING OF FAN

(71) Applicant: JOHN WUN-CHANG SHIH, Hsinchu City (TW)

(72) Inventor: JOHN WUN-CHANG SHIH, Hsinchu City (TW)

(21) Appl. No.: 15/390,550

(22) Filed: Dec. 26, 2016

(51) Int. Cl. F16C 32/06; F16C 33/72

(52) U.S. Cl. CPC F16C 32/0692; F16C 2360/46; F16C 33/72

(57) ABSTRACT

A drain proof seat of a fluid pressure bearing of a fan having a seat with a through hole for installing a fluid-pressure bearing; wherein a lower bottom of the bearing seat is formed with at least one drain-proof recess; and each drain-proof recess is a closed loop. The form of the drain-proof recess is a closed round recess, a non-round geometrical closed recess, a polygonal closed recess, or any other geometrical closed recess and all the recesses are co-centered with the through hole of the seat. Depths and widths of the drain-proof recesses are identical or not identical. Two adjacent drain-proof recesses are formed with an annular ring, and all the rings are co-centered and have identical or different width.

### FIELD OF THE INVENTION

The present invention relates to bake systems, in particular to a bake system with a well control module by using weight of the object to be baked as a control feature.

### BACKGROUND OF THE INVENTION

A conventional fans with fluid pressure bearings can be classified into two classes, AC and DC heat dissipation fans. A bottom of a DC fan has a non-penetrating hole for receiving a spindle. Therefore such kind of fan has no problem of fluid drainage, and thus no plug is needed for sealing the hole.

For AC fans, a penetrating hole is formed at a bottom of the bearing for receiving the bearing. After assembly and fluid injection, a hole must be sealed by using a cover. Then an inner adhesive sheet and an outer adhesive sheet are used to seal the cover so as to achieve the object of drain-proof of fluid.

However, practically, due to high temperature and temperature variation of the environment, the cover is deteriorate. The vibration of the bearing in rotation will cause the fatigue of elasticity and deformation of the cover. In rotation, due to vibration of the bearing, the inner pressure of the fluid will induce the adhesive sheets in the bottom releases to cause fluid to release out. As a result, the lifetime of the bearing is reduced. Therefore due to above conventional defects in the bearing, inventor of the present invention desired to resolve above mentioned problem without increasing cost and time needed so as to improve the drain-proof ability of of the sealing structure.

### SUMMARY OF THE INVENTION

Accordingly, object of the present invention is to provide a drain proof seat of a fluid pressure bearing of a fan, wherein the structure of the present invention will not increase any element to the original structure. It only forms recesses on the bottom of the seat. As a result, the drain proof effect is achieved without increasing time and cost needed and lifetime of the fluid pressure bearing is prolonged.

To achieve above object, the present invention provide a drain proof seat of a fluid pressure bearing of a fan having a seat with a through hole for installing a fluid-pressure bearing; wherein a lower bottom of the bearing seat is formed with at least one drain-proof recess; and each drain-proof recess is a closed loop. The form of the drain-proof recess is a closed round recess, a non-round geometrical closed recess, a polygonal closed recess, or any other geometrical closed recess and all the recesses are co-centered with the through hole of the seat. Depths and widths of the drain-proof recesses are identical or not identical. Two adjacent drain-proof recesses are formed with an annular ring, and all the rings are co-centered and have identical or different width.

### BRIEF DESCRIPTION OF THE DRAWINGS

FIG. 1 is a schematic view about the embodiment of the present invention.

FIG. 2 is an enlarged view of FIG. 1 of the present invention.

FIG. 3 shows one embodiment about the drain-proof recesses of the present invention.

FIG. 4 is a cross sectional view along line A-A of FIG. 3.

### BRIEF DESCRIPTION OF THE INVENTION

In order that those skilled in the art can further understand the present invention, a description will be provided in the following in details.

However, these descriptions and the appended drawings are only used to cause those skilled in the art to understand the objects, features, and characteristics of the present invention, but not to be used to confine the scope and spirit of the present invention defined in the appended claims.

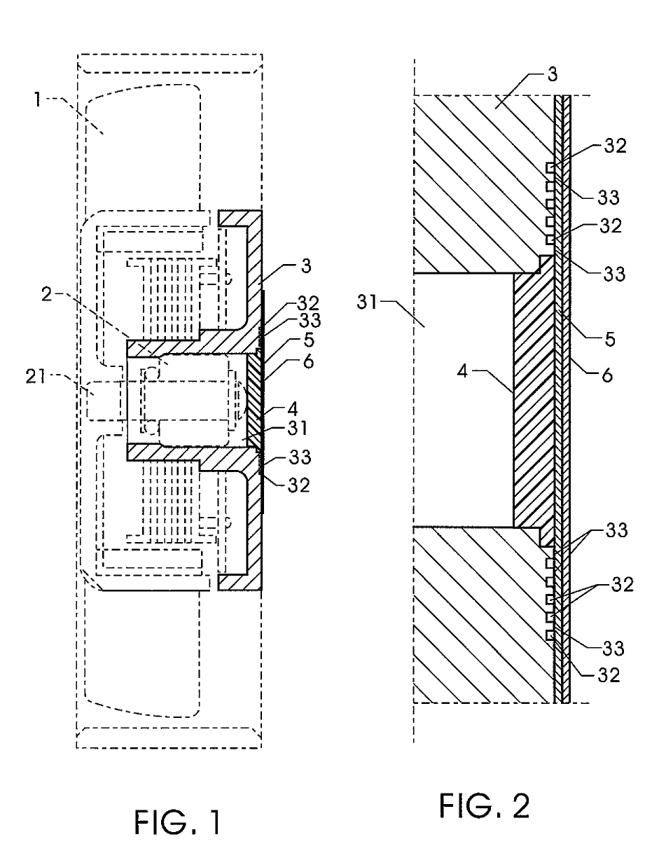

With reference to FIGS. 1 to 3, the structure of the present invention is illustrated.

A bearing seat 3 with a through hole 31 for installing a fluid-pressure bearing 2 for a fan 1. A spindle 21 passes through a hole center space of the spindle 21. A lower opening of the through hole 31 is tightly sealed by a pug 4.

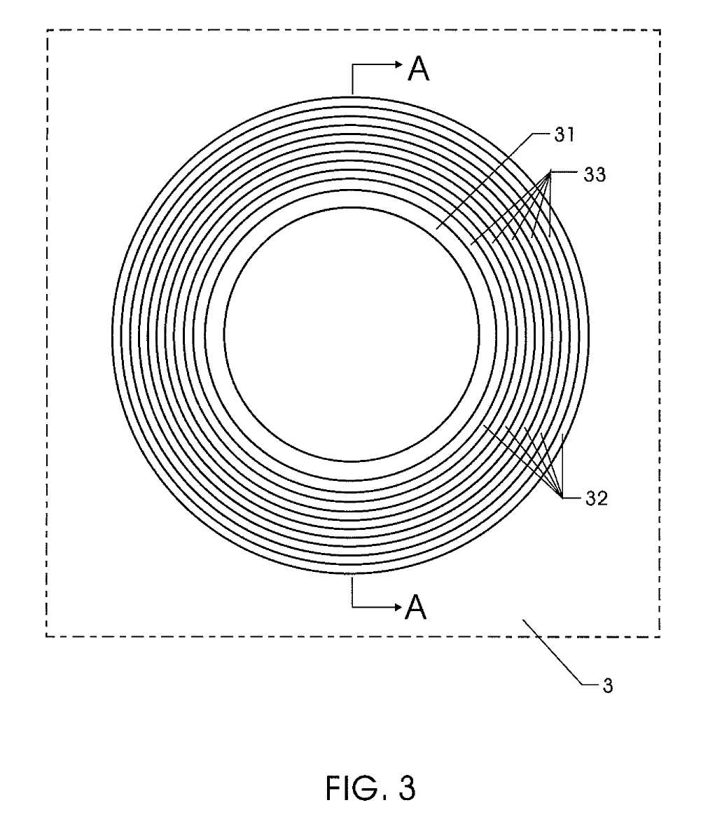

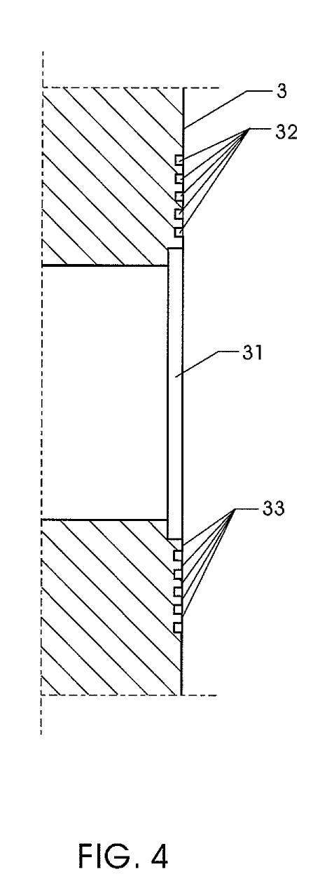

A lower bottom of the bearing seat 3 is formed with at least one drain-proof recess 32. The drain-proof recess 32 is a closed loop. The form of the drain-proof recess 32 may be a closed round recess, a non-round geometrical closed recess, a polygonal closed recess, or any other geometrical closed recess. It is possible that a plurality of drain-proof recesses 32 are formed on the bottom of the bearing seat 3 as illustrated in FIG. 3 of the present invention, and each drain-proof recess 32 has a round shape. In this structure, all the recesses are co-center (have an identical center) with the center of the through hole, but the depths of the drain-proof recesses 32 may be identical or not identical and the widths of the drain-proof recesses 32 may be identical or not identical. Two adjacent drain-proof recesses 32 are formed with an annular ring 33, and all the rings 33 are co-centered and have identical or different width.

In application of the present invention, a small area inner adhesive sheet 5 is adhesive to surfaces 33 of the annular rings 33 and then a large area outer adhesive sheet 5 are adhered to the outer side of the sinner adhesive sheet 5 so that the drain-proof recesses 32 are sealed with air filling in the drain-proof recesses 32. The air pressure has the effect of drain-proof. There are many drain-proof recesses 32 which generates many drain-proof effects so that air within the bearing 2 cannot be drained out. Even if oil is drained from the bearing 2, it will pass through all the drain-proof recesses 32, as a result, the oil pressure become weaker and weaker, as a result, it is very difficult for the oil to pass all the drain-proof recesses 32.

Therefore by the present invention, the structure of the present invention will not increase any element to the original structure. It only forms recesses on the bottom of the seat. As a result, the drain proof effect is achieved without increasing time and cost needed and lifetime of the fluid pressure bearing is prolonged.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A drain proof seat of a fluid pressure bearing of a fan having a seat with a through hole for installing a fluid-pressure bearing; wherein a lower bottom of the bearing seat is formed with at least one drain-proof recess; and each drain-proof recess is formed as a closed loop.

2. The drain proof seat of a fluid pressure bearing of a fan as claimed in claim 1, wherein a form of the drain-proof recess is a closed round recess, a non-round geometrical closed recess, a polygonal closed recess, or any other geometrical closed recess.

3. The drain proof seat of a fluid pressure bearing of a fan as claimed in claim 1, wherein all the recesses are co-centered with the through hole of the seat.

4. The drain proof seat of a fluid pressure bearing of a fan as claimed in claim 1, wherein depths of the drain-proof recesses are identical or not identical.

5. The drain proof seat of a fluid pressure bearing of a fan as claimed in claim 1, wherein widths of the drain-proof recesses are identical or not identical.

6. The drain proof seat of a fluid pressure bearing of a fan as claimed in claim 1, wherein two adjacent drain-proof recesses are formed with an annular ring, and all the rings are co-centered and have identical or different width.
